(19) United States
(12) Patent Application Publication
(10) Pub. No.: US 2003/0100472 A1
(43) Pub. Date: May 29, 2003

(54) Detergent tablet compositions

(75) Inventor: Antje Minke Wierenga, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/268,277

(22) Filed: Oct. 10, 2002

(30) Foreign Application Priority Data
Oct. 10, 2001 (EP) 0124333.6

(51) Int. Cl. C11D 17/00

(52) U.S. Cl. 510/446; 510/447; 510/507

(57) ABSTRACT

A tablet comprising a first zone which comprises surfactant and preferably also, detergency builder, and a second zone comprising a fabric softening clay, the concentration of fabric softening clay being higher in the second zone than in the first zone, the rate of disintegration in water of the second zone at 20° C. being greater than the rate of the first zone at the same temperature, the rates being measured over a time period from when the tablet is first immersed in the water.

### FIELD OF THE INVENTION

The present invention relates to detergent compositions in the form of tablets for use in fabric washing. Such tablets have the advantage that they do not require the user to measure out a volume of powder or liquid. Instead one or several tablets provide an appropriate quantity of composition for washing a single load in a washing machine or possibly by hand. They are thus easier for the consumer to handle and dispense.

### BACKGROUND OF THE INVENTION

Certain clays with ion exchange properties are known to be effective as fabric softeners, and are described in U.S. Pat. No. 4,062,647, EP-A-26 528, U.S. Pat. No. 3,959,155 and U.S. Pat. No. 3,936,537. Also clays have been disclosed for use as bodying agents in detergent laundry bars (as described in GB 2-A-145 109) and also for use in clear personal wash bars (as described in EP-A-210 842). A few documents have mentioned the possible use of such clay minerals in tablets, in certain limited circumstances.

WO-A-96/14834 is principally concerned with detergent compositions in powder form. It teaches the placing of a clay mineral in close proximity to, and preferably in the same granule as, an organic peroxyacid bleach to prevent patchy discolouration by the bleach. It also briefly mentions the possibility of using such a system in tablets.

JP-A-09/087,696 discloses compacted particulate material tablets which are based on nonionic surfactant. These tablets contain a clay mineral and a disintegration parameter.

WO-A-96/24656 describes the synergistic fabric softening effect achieved by a combination of a clay mineral with zeolite MAP (a zeolite P with silicate to aluminium ratio no greater than 1.33), and again mentions the possibility of using this system in tablets.

WO-A-01/09278 discloses a tablet comprising a smectite clay, an anionic surfactant and a material with a water solubility above 50 g/100 g of water of 20° C. The intention is that the clay acts as a partial replacement for a disintegrant. WO-A-99/40171, EP 1048719 and EP 1048718 disclose a zoned tablet in which the concentration of a fabric softening agent is greater in one zone than another zone. The aim is that release of the fabric conditioner from the zone in which it has the higher concentration is delayed in order to reduce interference between cleaning and softening mechanisms. One delay release mechanism disclosed is to completely enclose the fabric softening zone within the other zone. Alternatively, the fabric softening zone may be caused to disintegrate more slowly, e.g. by incorporating a disintegrant only in the other zone. One fabric softening agent utilised is a clay.

However, we have now found that contrary to expectation, by formulating a tablet such that a clay component is released before the majority of the main wash component, the clay is apparently able to interact with the fabric before the wash liquor is depleted by calcium hardness and/or negative interactions occur due to high ionic strength and/or pH caused by dissolution of the wash composition. In any event, deposition efficiency of the clay is enhanced. Improved deposition of a softening clay can improve fabric care benefits such as fabric softening, crease recovery and iron glide.

### DEFINITION OF THE INVENTION

The present invention provides a tablet comprising a first zone which comprises surfactant and preferably also, detergency builder, and a second zone comprising a fabric softening clay, the concentration of fabric softening clay being higher in the second zone than in the first zone, the rate of disintegration in the second zone at 20° C. being greater than the rate of the first zone at the same temperature, the rates being measured over a time period starting from when the tablet is first immersed in water.

In another aspect the present invention provides a tablet comprising a first zone which comprises surfactant and preferably also detergency builder and a second zone comprising a fabric softening clay. The concentration of the fabric softening clay being higher in the second zone than in the first zone wherein the first zone is substantially free of non-clay disintegrant and the second zone comprises an non-clay disintegrant.

### DETAILED DESCRIPTION OF THE INVENTION

Disintegration Rate Control

The second zone must have a higher rate of disintegration in water at 20° C. than the first zone at that temperature.

One way of achieving this is to put more disintegrant into the second zone than in the first zone, for example disintegrant being incorporated in the second zone but not in the first zone.

Additionally or alternatively, the second zone may completely surround the first zone. As used herein, reference to the rate of disintegration of the first and second zones refers to the rate of disintegration measured over a time period starting from when the tablet is first immersed in water at 20° C. Thus, for example, a first zone completely surrounded by a second zone could even have the same, or a greater intrinsic rate of disintegration than the second zone but being surrounded by the second zone, it will not substantially disintegrate until the second zone has largely disintegrated.

Additionally or alternatively, a swelling smectite clay may be used as the fabric softening clay in the second zone since smectite clays are able to act as both disintegrants and fabric softening agents.

Disintegrants

This section deals with disintegrants other than smectite clays which are discussed separately below under the heading “fabric softening clays”.

Preferred disintegrants are materials which have a solubility in (preferably deionised) water at 20° C. of at least 50 grams per 100 grams of water.

This disintegrant may be present in an amount which is at least 5 wt %, 7 wt % or 12 wt % of the tablet. Some of the disintegrant may be present in the base powder used to make the complete tablet formulation used for the second zone, whilst the remainder, preferably the majority, is added as a post-dosed ingredient to the base powder before tableting in the second zone. It is preferred that at least 75 wt % or even 85 wt % of the material is not in the base powder, but is added as a post-dosed ingredient.

A solubility of at least 50 grams per 100 grams of water at 20° C. is an exceptionally high solubility: many materials which are classified as water soluble are less soluble than this.

Some highly water-soluble materials which may be used are listed below, with their solubilities expressed as grams of solid required to form a saturated solution in 100 grams of water at 20° C.:

| Material | Water Solubility (g/100 g) |
|---|---|
| Sodium citrate dihydrate | 72 |
| Potassium carbonate | 112 |
| Urea | >100 |
| Sodium acetate (anhydrous) | 119 |
| Sodium acetate trihydrate | 76 |
| Magnesium sulphate 7H₂O | 71 |
| Potassium acetate | >200 |

Solubilities of some other materials at 20° C. are:

| Material | Water Solubility (g/100 g) |
|---|---|
| Sodium chloride | 36 |
| Sodium sulphate decahydrate | 21.5 |
| Sodium carbonate anhydrous | 8.0 |
| Sodium percarbonate anhydrous | 12 |
| Sodium perborate anhydrous | 3.7 |
| Sodium tripolyphosphate anhydrous | 15 |

Preferably this highly water-soluble disintegrant is incorporated as particles of the material in a substantially pure form (i.e. the majority of such particles contain over 95% by weight of the material). However, the said particles may contain material of such solubility in a mixture with other material, provided that material of the specified solubility provides at least 50% by weight of these particles.

The preferred disintegrant of high water-solubility are sodium citrate dihydrate, potassium carbonate, urea, sodium acetate in its anhydrous or trihydrate form, sodium acetate which is partially hydrated—as can be the case when it is spray dried, magnesium sulphate 7H₂O and potassium acetate. Mixtures of these can also be used. The most preferred of the aforementioned materials are sodium citrate dihydrate, sodium acetate in either its anhydrous, trihydrate or partially hydrated form. Mixtures of these most preferred materials can also be used.

Another suitable class of disintegrants comprises cellulose disintegrants.

Fabric Softening Clays

It is preferred that the fabric softening clay is a fabric softening smectite clay with a ion exchange capacity of at least 50, or more preferably 70 meq/100 g of dry clay. The cation exchange capacity of a clay relates to the expandable properties of the clay and to the charge of the clay, and is conventionally measured by electrodialysis or by exchange with ammonium ions followed by titration. These procedures are set out in Grimshaw, “The Chemistry and Physics of Clays”, pp. 264-265, Interscience (1971).

It is further preferred that the weight ratio of fabric softening clay to disintegrant in the second zone is from 1:1 to 1:10.

Smectite Clay Minerals

Smectite clay minerals in themselves promote disintegration of a tablet in water. Smectites are 2:1 clay minerals in which aluminium oxide or magnesium are present in a silicate lattice.

Suitable smectite clay minerals include montmorillonite, beidellite, hectorite, nontronite, saponite and sauconite, particularly those having an alkali or alkaline earth metal ion between the clay mineral layers. Montmorillonite is the preferred mineral, and clays which contain a majority of montmorillonite, such as bentonite, are a preferred source of this clay mineral. It may be preferred that the clay is at least 90% montmorillonite. Bentonites containing calcium or sodium montmorillonite (known as calcium or sodium bentonites) are particularly preferred.

Suitable bentonite clays are sold under the trade names of Laundrosil DW, M630 Agglomerat and EX 0276 Agglomerat clays available from Süd Chemie, Germany, Detersoft G1S, Detersoft G1B, Detercal G1 FC and Detercal G2 FC clays, available from Laviosa, Italy, and Bentonite QPC 200G and QTIC 200G clays available from Colin Stewart Minerals, UK.

It is preferred that the majority of the clay particles have a particle size between 0.35 microns and 0.85 microns. It is further preferred that 90% of the clay particles have diameters between 0.35 microns and 0.85 microns.

The clay mineral is preferably present at a level from 0.5 to 40% by weight of the tablet, these percentages referring to the level of the clay mineral per se. The upper limit on the level of clay mineral may be as low as 8 wt %, 10 wt %, 15 wt %, 20 wt % or 30 wt %, with 10 wt % being particularly preferred. The lower limit on the level of clay mineral may be 1 or 3 wt %, or even 5 wt %. In situations where the clay mineral is provided in an impure form, e.g. unprocessed, the amount of the impure clay material may necessarily be higher than the limits for the clay mineral itself.

Clays are available in which the amount of crystalline silica is below 5 wt %, and these are suitable for use in the present invention. It may be preferred that in the present invention the chromium, nickel and cobalt levels in the tablet, which usually arise due to these trace elements being found in clays, are less than 5 ppm.

Detergent-Actives

Compositions which are compacted in tablets of this invention contain one or more detergent-actives. In a fabric washing composition, these preferably provide from 5% to 50% by weight of the overall tablet composition, more preferably from 8 or 9% by weight of the overall composition up to 25, 40 or 50% by weight. The detergent-active may be anionic (soap or non-soap), cationic, zwitterionic, amphoteric, nonionic or any combination of these. Many suitable detergent surfactants are commercially available and are fully described in the literature, for example in “Surface Active Agents and Detergents”, Volumes I and II, by Schwartz, Perry and Berch.

Anionic surfactant is present in an amount of from 0.5 to 40% by weight, preferably from 2% or 4% up to 20%, 30% or 40% by weight of the tablet composition.

Synthetic (i.e. non-soap) anionic surfactants are well known to those skilled in the art. Examples include alkylbenzene sulphonates, particularly sodium linear alkylbenzene sulphonates having an alkyl chain length of C₈-C₁₅; olefin sulphonates; alkane sulphonates; dialkyl sulphosuccinates; and fatty acid ester sulphonates.

Primary alkyl sulphate having the formula ROSO₃⁻ M⁺

in which R is an alkyl or alkenyl chain of 8 to 18 carbon atoms especially 10 to 14 carbon atoms and M⁺ is a solubilising cation, is commercially significant as an anionic surfactant. Linear alkyl benzene sulphonate of the formula;

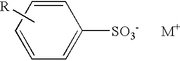

where R is linear alkyl chain of 8 to 15 carbon atoms and M⁺ is a solubilising cation, especially sodium, is also a commercially significant anionic surfactant.

Frequently, such linear alkyl benzene sulphonate or primary alkyl sulphate of the formula above, or a mixture thereof, will be the desired anionic surfactant and may provide 75 to 100 wt % of any anionic non-soap surfactant in the composition.

In some forms of this invention the amount of non-soap anionic detergent lies in a range from 5 to 20 wt % of the tablet composition.

It may also be desirable to include one or more soaps of fatty acids. These are preferably sodium soaps derived from naturally occurring fatty acids, for example, the fatty acids from 25 coconut oil, beef tallow, sunflower or hardened rapeseed oil.

Suitable nonionic detergent compounds which may be used include in particular the reaction products of compounds having a hydrophobic group and a reactive hydrogen atom, for example, aliphatic alcohols, acids, amides or alkyl phenols with alkylene oxides, especially ethylene oxide either alone or with propylene oxide.

Specific nonionic detergent compounds are alkyl (C₈₋₂₂) phenol-ethylene oxide condensates, the condensation products of linear or branched aliphatic C₈₋₂₀ primary or secondary alcohols with ethylene oxide, and products made by condensation of ethylene oxide with the reaction products of propylene oxide and ethylene-diamine. Other nonionic detergent compounds include alkylpolyglycosides, long-chain amine oxides, tertiary phosphine oxides, and dialkyl sulphoxides.

Especially preferred are the primary and secondary alcohol ethoxylates, especially the C₉₋₁₁ and C₁₂₋₁₅ primary and secondary alcohols ethoxylated with an average of from 5 to 20 moles of ethylene oxide per mole of alcohol.

In certain forms of this invention the amount of nonionic detergent lies in a range from 4 to 40 wt %, better 4 or 5 to 30 wt % by weight of the composition.

Many nonionic detergent-active compounds are liquids. These may be absorbed on a porous carrier or on particles of the composition. Preferred carriers include zeolite; zeolite granulated with other materials, for example Wessalith CS (Trade Mark), Wessalith CD (Trade Mark) or Vegabond GB (Trade Mark); sodium perborate monohydrate; Burkeite (spray-dried sodium carbonate and sodium sulphate as disclosed in EP-A-221776 of Unilever); and layered sodium silicate as described in U.S. Pat. No. 4,664,839.

Amphoteric or zwitterionic detergent compounds may also be used in the compositions of the present invention, but this is not normally desired due to their relatively high cost. If any amphoteric or zwitterionic detergent compositions are used it is generally in small amounts in compositions which are based on the much more commonly used synthetic anionic and/or nonionic detergent compositions.

Detergency Builder

The detergency builder is preferably present in an amount of 15 wt %-70 wt %, more preferably from 15 to 60 wt %, e.g. 20-55 wt %. Especially preferred are compositions comprising 15 to 60 wt % of water-insoluble detergency builder.

The detergency builder may be provided wholly by water-soluble materials, or may be provided in large part or even entirely by water-insoluble materials with water-softening properties.

Alkali-metal aluminosilicates are strongly favoured as environmentally acceptable water-insoluble builders for fabric washing. Alkali metal (preferably sodium) aluminosilicates may be either crystalline, amorphous or mixtures thereof, having the general formula:

0.8-1.5 Na₂O.Al₂O₃.0.8-6SiO₂.xH₂O

These materials contain some bound water (indicated as “xH₂O”) and are required to have a calcium ion exchange capacity of at least 50 mg CaO/g. The preferred sodium aluminosilicates within the above formula contain 1.5-3.5 SiO₂ units. Both amorphous and crystalline aluminosilicates can be prepared by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X, the novel zeolite P described and claimed in EP 384070 (Unilever) and mixtures thereof.

Conceivably a water-insoluble detergency builder could be a layered sodium silicate as described in U.S. Pat. No. 4,664,839. NaSKS-6 is the trademark for a crystalline layered silicate marketed by Hoechst (commonly abbreviated as “SKS-6”). NaSKS-6 has the delta-Na₂SiO₅ morphology form of layered silicate. It can be prepared by methods such as described in DE-A-3417649 and DE-A-3742043. Other such layered silicates, such as those having the general formula NaMSiₓO_{2x+1-y}H₂O wherein M is sodium or hydrogen, x is a number from 1.9 to 4, preferably 2, and y is a number from 0 to 20, preferably 0 can be used.

Water-soluble phosphorous-containing inorganic detergency builders, include the alkali-metal ortophosphates, metaphosphates, pyrophosphates and polyphosphates. Specific examples of inorganic phosphate builders include sodium and potassium tripolyphosphates, orthophosphates and hexametaphosphates.

Non-phosphorous water-soluble builders may be organic or inorganic. Inorganic builders that may be present include alkali metal (generally sodium) carbonate; while organic builders include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates and hydroxyethyliminodiacetates.

Tablet compositions preferably include polycarboxylate polymers, more especially polyacrylates and acrylic/maleic copolymers which can function as builders and also inhibit unwanted deposition onto fabric from the wash liquor. Nitrilo triacetate may also be used as the builder. The trisodium salt is especially preferred.

Bleach System

Tableted detergent compositions according to the invention may contain a bleach system. This preferably comprises one or more peroxy bleach compounds, for example, inorganic persalts or organic peroxyacids, which may be employed in conjunction with activators to improve bleaching action at low wash temperatures. If any peroxygen compound is present, the amount is likely to lie in a range from 10 to 25% by weight of the composition.

Preferred inorganic persalts are sodium perborate monohydrate and tetrahydrate, and sodium percarbonate, advantageously employed together with an activator. Bleach activators, also referred to as bleach precursors, have been widely disclosed in the art. Preferred examples include peracetic acid precursors, for example, tetraacetylethylene diamine (TAED), which is now in widespread commercial use in conjunction with sodium perborate; and perbenzoic acid precursors. The quaternary ammonium and phosphonium bleach activators disclosed in U.S. Pat. Nos. 4,751,015 and 4,818,426 (Lever Brothers Company) are also of interest. Another type of bleach activator which may be used, but which is not a bleach precursor, is a transition metal catalyst as disclosed in EP-A-458397, EP-A-458398 and EP-A-549272. A bleach system may also include a bleach stabiliser (heavy metal sequestrant) such as ethylenediamine tetramethylene phosphonate and diethylenetriamine pentamethylene phosphonate.

As indicated above, if a bleach is present and is a water-soluble inorganic peroxygen bleach, the amount may well be from 10% to 25% by weight of the composition.

Other Detergent Ingredients

The detergent tablets of the invention may also contain one of the detergency enzymes well known in the art for their ability to degrade and aid in the removal of various soils and stains. Suitable enzymes include the various proteases, cellulases, lipases, amylases, and mixtures thereof, which are designed to remove a variety of soils and stains from fabrics. Examples of suitable proteases are Maxatase (Trade Mark), as supplied by Gist-Brocades N.V., Delft, Holland, and Alcalase (Trade Mark), and Savinase (Trade Mark), as supplied by Novo Industri A/S, Copenhagen, Denmark. Detergency enzymes are commonly employed in the form of granules or marumes, optionally with a protective coating, in amount of from about 0.1% to about 3.0% by weight of the composition; and these granules or marumes present no problems with respect to compaction of a detergent composition to form a tablet.

The detergent tablets of the invention may also contain a fluorescer (optical brightener), for example, Tinopal (Trade Mark) DMS or Tinopal CBS available from Ciba-Geigy AG, Basel, Switzerland. Tinopal DMS is disodium 4,4′bis-(2-morpholino-4-anilino-s-triazin-6-ylamino) stilbene disulphonate; and Tinopal CBS is disodium 2,2′-bis-(phenyl-styryl) disulphonate.

An antifoam material is advantageously included, especially if the detergent tablet is primarily intended for use in front-loading drum-type automatic washing machines. Suitable antifoam materials are usually in granular form, such as those described in EP 266863A (Unilever). Such antifoam granules typically comprise a mixture of silicone oil, petroleum jelly, hydrophobic silica and alkyl phosphate as antifoam active material, sorbed onto a porous absorbed water-soluble carbonate-based inorganic carrier material. Antifoam granules may be present in an amount up to 5% by weight of the composition.

The detergent tablets of the invention may also contain a perfume composition. The perfume composition will normally consist of a plurality of perfumery materials having a fragrance, and may include a minor proportion (less than 50% by weight of the perfume) of odourless organic solvent which serves as a carrier. Perfume compositions suitable for use in fabric washing have been disclosed in various documents including EP 332259 (Procter) and are available from perfume houses such as Quest International, Naarden, Netherlands. A perfume composition may have deodorant properties, as disclosed in U.S. Pat. Nos. 4,304,679, 4,663,068, 5,501,805 and 5,55,4588.

The total amount of perfume in a tablet is likely to be from 0.1 to 5% by weight of the tablet, preferably from 0.1 to 2%. In many fabric washing products, the amount of perfume is less than 1%. The total amount of perfume in a tablet may therefore be in a range from 0.1 to 0.5%.

Further ingredients which can optionally be employed in the detergent tablet of the invention include anti-redeposition agents such as sodium carboxymethylcellulose, straight-chain polyvinyl pyrrolidone and the cellulose ethers such as methyl cellulose and ethyl hydroxyethyl cellulose, heavy metal sequestrants such as EDTA, and colorants or coloured speckles.

Other Fabric Softeners

Although the clay mineral in the tablet acts as a fabric softener, it may be desirable to use additional fabric softening agents, although the invention includes tablets where the clay minerals are the only fabric softeners. The total amount of fabric softening agents, including the amount of clay minerals, in the tablets of the invention will, in general, be from 0.5 or 3 wt % up to 30 or 50 wt % of the tablet. The lower limit may be as high as 5 wt % and the upper limit as low as 10 wt %.

A discussion of materials which are known as fabric softening agents and which may be used in the tablets of the present invention is found in WO 94/24999.

Many suitable and commercially important fabric softening agents are organic compounds containing quaternary nitrogen and at least one carbon chain of 6 to 30 carbon atoms, e.g. in an alkyl, alkenyl or aryl substituted alkyl or alkenyl group with at least six aliphatic carbon atoms.

Other suitable fabric softening agents are the analogous tertiary amines and imidazolines, other aliphatic alcohols, esters, amines or carboxylic acids incorporating a C₈ to C₃₀ alkyl, alkenyl or acyl group, including esters of sorbitan and esters of polyhydric alcohols, and mineral oils. Certain clays are important as fabric softening agents. Another class of materials used as fabric softening agents are hydrophobically modified cellulose ethers.

Some specific instances of fabric softening agents which may be used in tablets of the present invention are:

(1) Acyclic quaternary ammonium compounds wherein two N-substituents are hydrocarbyl groups containing from 15 to 22 carbon atoms, the third N-substituent is a saturated alkyl or hydroxy alkyl group containing from 1 to 4 carbon atoms, and the fourth substituent may be defined as for either of the other substituents or may be phenyl. The counter-anion is preferably selected from halide, methyl sulphate and ethyl sulphate radicals.

Throughout this discussion of fabric softening agents, the expression hydrocarbyl group refers to alkyl or alkenyl groups optionally substituted or interrupted by functional groups such as —OH, —O—, COHN, —COO— etc.

Representative examples of these quaternary softeners include ditallow dimethyl ammonium chloride; di(hydrogenated tallow) dimethyl ammonium chloride; di(coconut) dimethyl ammonium chloride; di(coconut) dimethyl ammonium methosulphate.

(2) Ester Quaternary Ammonium Salts

A number of quaternary ammonium salts containing ester groups, including those disclosed in FR-A-2054337 (BASF), EP-A-345842 A2 (Procter), EP-A-239910 (Procter) and U.S. Pat. No. 4,137,180 (Lever) are suitable for use in the tablets of the present invention. Examples of suitable materials include N,N-di(tallowyl-oxyethyl), N-methyl, N-hydroxyethyl ammonium chloride and 1,2-ditallowyloxy-3-trimethyl ammoniopropane chloride. In these materials, tallowyl may be replaced with cocoyl, palmoyl, lauryl, oleyl, stearyl and palmityl groups.

3) Quaternary Imidazolinium Salts

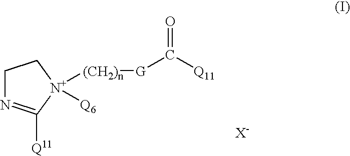

A further class of cationic softener materials is the imidazolinium salts of generic formula (I)

wherein Q₁₁ is a hydrocarbyl group containing from 6 to 24 carbon atoms, G is —N(H)—, or —O—, or —NQ₂—, n is an integer between 1 and 4, and Q₂ and Q₆ are as defined above.

Preferred imidazolinium salts include 1-methyl-1-(tallowylamido) ethyl-2-tallowyl-4,5 dihydro imidazolinium methosulphate and 1-methyl-1-(palmitoylamido) ethyl-2-octadecyl-4,5dihydroimidazolinium chloride. Other useful imidazolinium materials are 2-heptadecyl-1-methyl-1-(2 stearylamido) ethyl imidazolinium chloride and 2-lauryl-1-hydroxyethyl-1-oleyl imidazolinium chloride. Also suitable are the imidazolinium fabric softening components of U.S. Pat. No. 4,127,489.

4) Primary, Secondary and Tertiary Amines.

Primary, secondary and tertiary amines are useful as softening agents. One N-substituent is a hydrocarbyl group containing from 6 to 24 carbon atoms, the second N-substituent is hydrogen or a hydrocarbyl group containing from 1 to 22 carbon atoms and the third N-substituent can be hydrogen or a hydrocarbyl group containing from 1 to 6 carbon atoms. Preferably amines are protonated with hydrochloric acid, orthophosphoric acid or citric acid or any other similar acids for use in cleaning compositions of the present invention. Specific examples of tertiary amines that are suitable for use in the tablets of the present invention are those disclosed in EP 213720 (Unilever).

5) Cellulase

British Patent Specification GB 1 368 599 (Unilever) discloses the use of cellulolytic enzymes, i.e. cellulases, as harshness reducing agents. It is thought that cellulase achieves its anti-harshening effect on, e.g. cotton, by cleaving the cellulosic fibrils which form on the cotton fibres during the normal washing process. This cleavage prevents the fibrils from bonding together and thereby introducing a degree of rigidity into the fabric.

It is preferred to use cellulases which have an optimum activity at alkaline pH values, such as those described in British Patent Specifications GB 2 075 028 A (Novo Industrie A/S), GB 2 095 275 A (Kao Soap Co Ltd) and GB 2 094 826 A (Kao Soap Co Ltd).

Examples of such alkaline cellulases are cellulases produced by a strain of Humicola insolens (Humicola grisea var. thermoidea), particularly the Humicola strain DSM 1800, cellulases produced by a fungus of Bacillus N or a cellulase 212-producing fungus belonging to the genus Aeromanas, and cellulase extracted from the hepatopancreas of a marine mollusc (Dolabella Auricula Solander).

The amount of cellulase in a tablet of the invention will, in general, be from 0.1 to 10% by weight. In terms of cellulase activity the use of cellulase in an amount corresponding to from 0.25 to 150 or higher regular Cₓ units/gram of detergent composition is within the preferred scope of the present invention. A most preferred range of cellulase activity, however, is from 0.5 to 25 regular Cₓ units/gram of the detergent composition.

Particle Size and Distribution

A detergent tablet of this invention, or a discrete region of such a tablet, is a matrix of compacted particles.

Preferably the particulate composition has an average particle size in the range from 200 to 2000 μm, more preferably from 250 to 1400 μm. Fine particles, smaller than 180 μm or 200 μm may be eliminated by sieving before tableting, if desired, although we have observed that this is not always essential.

Tableting

Tableting entails compaction of a particulate composition.

A variety of tableting machinery is known, and can be used. Generally it will function by stamping a quantity of the particulate composition which is confined in a die.

Manufacture of a tablet with two layers of differing composition may be carried out by placing a predetermined quantity of one composition in a mould, then adding a second composition on top, and next driving a die into the mould to cause compression.

Alternatively, a predetermined quantity of a first composition may be placed in a mould and compacted by driving a die into the mould, followed by removing the die, adding a second composition and compacting again.

Tableting machinery able to carry out such operations is known. For example, suitable tablet presses are available from Fette and from Korsch.

Tableting may be carried out at ambient temperature or at a temperature above ambient which may allow adequate strength to be achieved with less applied pressure during compaction. In order to carry out the tableting at a temperature which is above ambient, the particulate composition is preferably supplied to the tableting machinery at an elevated temperature. This will of course supply heat to the tableting machinery, but the machinery may be heated in some other way also.

It is known to make tablets using microwave radiation. WO 96/06156 mentions that hydrated materials are useful in this special circumstance to cause sintering.

For the present invention, if any heat is supplied, it is envisaged that this will be supplied conventionally, such as by passing the particulate composition through an oven, rather than by any application of microwave energy.

The size of a tablet will suitably range from 10 to 160 grams (gm), preferably from 15 to 60 gm, depending on the conditions of intended use, and whether the tablet represents a dose for an average load in a fabric washing or a fractional part of such a dose. The tablets may be of any shape. However, for ease of packaging they are preferably blocks of substantially uniform cross-section, such as cylinders or cuboids. The overall density of a tablet is preferably 1040 or 1050 gm/litre, better 1100 gm/litre, up to 1300 or 1350 gm/litre or even more. The tablet density may well lie in a range up to no more than 1250 or even 1200 gm/litre.

While the starting particulate composition may in principle have any bulk density, the present invention is especially relevant to tablets made by compacting powders of relatively high bulk density, because of their greater tendency to exhibit disintegration and dispersion problems. Such tablets have the advantage that, as compared with a tablet derived from a low bulk density powder, a given dose of composition can be presented as a smaller tablet.

Thus the starting particulate composition may suitably have a bulk density of at least 400 g/litre, preferably at least 500 g/litre, and advantageously at least 700 g/litre. Granular detergent compositions of high bulk density prepared by granulation and densification in a high-speed mixer/granulator, as described and claimed in EP 340013A (Unilever), EP 352135A (Unilever), and EP 425277A (Unilever), or by the continuous granulation/densification processes described and claimed in EP 367339A (Unilever) and EP 390251A (Unilever), are inherently suitable for use in the present invention.

Preferred embodiments of the invention will now be described by way of example only. Further modification within the scope of the present invention will be apparent to the person skilled in the art.

### EXAMPLES

### Example 1

A powder Formulation according to Composition A was prepared by conventional granulation:

Composition A

| | Wt % |
|---|---|
| Na alkyl benzene sulphonate | 9.0 |
| Nonionic C₁₂ av. 7EO units | 3.5 |
| Soap | 1.0 |
| Zeolite A | 22.2 |
| Bentonite clay (Detersoft G1S) | 10.0 |
| Na citrate dihydrate | 2.5 |
| Na acetate trihydrate | 20.0 |
| Na₂ CO₃ | 3.5 |
| Sodium carboxymethyl cellulose | 0.3 |
| Silicone Antifoam | 2.0 |
| Fluorescer | 0.1 |
| Soil Release Polyner | 0.5 |
| Na disilicate | 2.1 |
| Na Percarbonate | 11.3 |
| TAED | 4.0 |
| Dequest Sequestrant | 3.0 |
| Enzymes | 1.0 |
| Perfume & Minors | 4.5 |
| | 100% |

This Composition A was compacted into “control” tablets in conventional manner. The speed of disintegration of tablets was measured under static conditions.

A pre-weighed tablet was placed (on its side) on a metal grid with 1×1 cm mazes and the tablet and grid was then immersed in 15° French Hardness tap water at 20° C. so that 2 cm of water was above the top of the immersed tablet. After 60 seconds the metal grid was carefully taken out of the water and the wet tablet residue is weighed. If the tablet had fully disintegrated in this time then the time taken for 100% disintegration was recorded.

The tablet of composition A was found to disintegrate within 3-4 minutes.

Composition B below was formulated in two parts (a) and (b), by conventional granulation techniques.

Composition B

| | Wt % |
|---|---|
| Part (a) | |
| Na alkyl benzene sulphonate | 9.0 |
| Nonionic C₁₂ av. 7EO units | 3.5 |
| Soap | 1.0 |
| Zeolite A | 22.2 |
| Na citrate dihydrate | 2.5 |
| Na acetate trihydrate | 15.0 |
| Na₂CO₃ | 3.5 |
| Sodium carboxymethyl cellulose | 0.3 |
| Silicone Antifoam | 2.0 |
| Fluorescer | 0.1 |
| Soil Release Polyner | 0.5 |
| Na disilicate | 2.1 |
| Na Percarbonate | 11.3 |
| TAED | 4.0 |
| Dequest Sequestrant | 3.0 |
| Enzymes | 1.0 |
| Perfume & Minors | 4.5 |
| | 85% |
| Part (b) | |
| Smectite clay | 10.0 |
| Na Acetate trihydrate | 5.0 |
| | 15% |
| | 100% |

The Composition was compacted into a bilayer tablet of Example 1, by the method described in WO-A-99/40171. This tablet respectively comprised layers formed of composition parts (a) and (b), having the same total weight (40 g) and strength as the control tablets. In the disintegration test, it was found that the tablet of Composition B disintegrated in two steps. Part (a) disintegrated within 5-7 minutes whereas part (b) disintegrated within 1 minute.

In a Miele washing machine, terry-towel samples were washed respectively with the control tablet and the tablet of Example 1. The tablet to liquor ratio was 6.5 g/l and the fabric to liquor ratio was 2.3 g/l. The wash temperature was 40° C. and the wash time was 30 minutes.

After rinsing and drying according to the standard program, the machine was emptied and cloths were removed. The cloths were then further lay dried for an hour.

After 3 such washes (2 repeats) the clothes were dried flat and then conditioned overnight by storing them at constant temperature (20° C.) and relative humidity (65%RH) before evaluation.

Iron-deposition on clothes was measured by x-ray fluorescence. This is a measure of clay deposition (the iron content of the clay being significantly higher than that of zeolite). The iron levels were significantly higher for the tablets of Example 1 than for the control tablets.

These results show that it is beneficial for clay deposition to formulate/manufacture a tablet in such a way that all clay is in one layer that disintegrates faster than the rest of the tablet.

1. A tablet comprising a first zone which comprises surfactant and preferably also detergency builder and a second zone comprising a fabric softening clay. The concentation of the fabric softening clay being higher in the second zone than in the first zone is substantially free of non-clay disintegrant and the second zone comprises a non-clay disintegrant.

2. A tablet according to 1, wherein the first zone is substantially free of non-clay disintegrant.

3. A tablet according to 1, wherein the second zone comprises a non-clay disintegrant.

5. A tablet according to claim 1, wherein the disintegrant comprises a material with a water-solubility which exceeds 50 g per 100 g of water at 20° C.

6. A tablet according to claim 1, wherein the disintegrant is at least 7 wt % of the second zone.

7. A tablet according to any of claim 1, wherein the weight ratio of fabric softening clay to disintegrant is from 1:1 to 1:10.

8. A tablet according to any of claim 1, wherein the disintegrant is selected from sodium citrate dihydrate, potassium carbonate, urea, sodium acetate in either its anhydrous, trihydrate or partially hydrated form, magnesium sulphate.7H₂O, potassium acetate, and mixtures thereof.

9. A tablet according to claim 1, wherein the fabric softening clay has an ion exchange capacity of at least 70 meq/100 g of dry clay.

10. A tablet according to claim 9, wherein the fabric softening clay is a montmorillonite.

11. A tablet according to claim 1, wherein the fabric softening clay comprises a bentonite clay.

12. A tablet according to any claim 1, wherein more than 50% by weight of the clay particles have a particle size between 0.35 mm and 0.85 mm.

13. A tablet according to claim 1, wherein the first zone constitutes from 50% to 95%, by weight of the tablet.

14. A tablet according to claim 1, wherein the second zone comprises from 10% to 90%, by weight of the second zone of the fabric softening clay.
